(19) United States
(12) Patent Application Publication
(10) Pub. No.: US 2026/0360022 A1
(43) Pub. Date: Nov. 12, 2026

(54) DATA GENERATION DEVICE AND DATA GENERATION METHOD

(71) Applicant: Hitachi, Ltd., Tokyo (JP)

(72) Inventors: Ryo SAKAI, Tokyo (JP); Kiyoto ITO, Tokyo (JP)

(73) Assignee: Hitachi, Ltd., Tokyo (JP)

(21) Appl. No.: 19/114,187

(22) PCT Filed: Sep. 7, 2023
(86) PCT No.: PCT/JP2023/032742

§ 371 Date: Mar. 21, 2025

(30) Foreign Application Priority Data
Nov. 18, 2022 (JP) 2022-184602

(51) Int. Cl. G06T 11/00; G06V 20/64

(52) U.S. Cl. CPC G06T 11/00; G06V 20/64

(57) ABSTRACT

A data generation device and method with which, when a camera is positioned, it is possible to generate, from original learning data, an image and teaching information that are learning data for a learning-based technique, and to reduce the labor involved in collecting the learning data. A pseudo-image generation unit inputs a second parameter, which pertains to a virtual camera, to a space constructor that has been trained using at least an image of an object and a first parameter, which pertains to a real camera when the image of the object is captured, thereby generating a pseudo-image of the object that corresponds to the second parameter; and a teaching information update unit that, by using the first and second parameters and three-dimensional information pertaining to the object, updates teaching information corresponding to the first parameter to teaching information corresponding to the second parameter in a teaching information storage unit.

### TECHNICAL FIELD

The present invention relates to a data generation device and a data generation method to generate leaning data used for learning in a region estimation approach related to an object in an image.

### BACKGROUND ART

One of tasks performed by an industrial robot such as a guided vehicle and the like is work to transport a cart utilized in a warehouse or factory. The work to transport a cart is work to transport the cart loaded with parts and/or the like, to a place of dispatch or an assembly place within a warehouse or factory in conformance with a transmittal form or an assembling instruction manual, which is unskilled work and work with heavy load requiring physical load of a worker. For greater efficiency of the work to transport a cart, it is to be expected to expand the application of a guided vehicle having a region estimation function related to an object in an image resulting from image processing.

Accuracy of the region estimation related to an object in an image is increasingly improved with the advancement of deep learning technology. The knowledge and information obtained thereby are applied to the field of automated driving. However, there still remain issues unique to the learning based approach.

Consideration is given, for example, to a system in which the learning based approach is used for an image of a cart captured by a camera to estimate a region used to tow the cart and, based on the estimation results, the cart is towed by a guided vehicle. As a possible piece of the learning data at this time, there is teaching information indicating an image of an object of interest such as the cart and a specific region such as the region used to tow the cart.

If a camera body of the system and/or the camera location is changed, the camera after the change will acquire an image differing in photographed condition of an object of interest from an image assumed to result from input of the region estimation through the learning based approach. For example, changing the camera bodies causes a change in a focal length of the camera. Upon change of the focal length of the camera, even if an object of interest is captured by the camera at the same location, this causes a change of the region occupied in the image by the object of interest. Also, changing the camera location causes a change in the relationship of relative position/orientation between the camera and the object of interest. Upon change of the camera location, even if the same camera captures, then this causes a change of the photographed condition of the object of interest on the image.

In the learning based approach, it is assumed that the region estimation is executed by inputting an image with the same photographed condition of the object of interest as that of the image used in the learning data. Therefore, if the region estimation is executed on an image with a different photographed condition of the object of interest from that thereof when the learning data is collected, there is concern about a reduction in estimation accuracy. Methods to prevent the reduction of the estimation accuracy include, for example, a method of re-collecting and re-learning the learning data after the change related to the camera. However, the collection of the learning data has a problem that requires person-hours involved in capturing an image and person-hours involved in labeling the region information used to tow the cart which is the teaching information for the captured image.

The background art in the technical field includes technologies such as, for example, Patent Literature 1 and Patent Literature 2.

Patent Literature 1 discloses in the abstract that an image captured by the target camera is used as a style target image to train a style transformer network to perform a style transformation that transforms any photorealistic input image into a transformed image; the transformed image has contents of the input image to maintain photorealistic quality of the input image, and has a style that matches a style of the style target image; the trained style transformer network is used to transform training image of an original training dataset into transformed training images; each transformed training image is labelled with the training labels of the corresponding training image of the original training dataset, to form an augmented training dataset; and the augmented training dataset is used to train a deep neural network (DNN) to perform specified work.

Patent Literature 2 also discloses in the abstract that a target space in a real environment is three-dimensionally reproduced within a virtual space including a dynamic object; a comparison is performed between the positional relationship of objects existing in the virtual space and an estimation result by machine learning in the real environment in order to determine the success or failure of the estimation result by the machine learning in the real environment automatically.

Patent Literature 2 also describes, in paragraphs 0037 to 0041 and the like, that if any object is not detected, an image and annotation data are generated for learning data expansion in response to an error in order to re-learn an object detection model.

In addition to Patent Literature 1 and Patent Literature 2, technology of NeRF (Neural Radiance Fields) is known. NeRF is a technology with which a parameter of a camera capturing an image of an object of interest is used to learn a neural network representing a three-dimensional space thus captured, and a photorealistic image of the object of interest captured with a camera located virtually is generated.

### CITATION LIST

### Patent Literature

Patent Literature 1: Japanese Unexamined Patent Application Publication No. 2019-32821
Patent Literature 2: Japanese Unexamined Patent Application Publication No. 2022-81081

### SUMMARY OF INVENTION

### Technical Problem

As described above, if a change related to a camera occurs, this raises a problem of the need of a lot of person-hours to re-collect learning data for preventing a reduction in estimation accuracy in the learning based approach.

It is possible in Patent Literature 1 to perform a style transformation on a training image of an original training dataset which is a photorealistic input image in order to form an augmented training dataset. However, because the style transformation is simply performed, Patent Literature 1 has a problem of an inability to generate an image in response to a change in camera position. Likewise, in Patent Literature 1, for the training labels which are teaching information, because the training labels prior to the style transformation are utilized without any change, there is a problem of an inability to respond to a change in camera position.

In Patent Literature 2, for the image for the learning data expansion, an artificial image in which a scene is reproduced by three-dimensional computer graphics as shown in FIG. 6(c) and FIG. 10(c) of Patent Literature 2, is used. For the annotation data for the learning data expansion, a bounding box, as shown in FIG. 6(d) of Patent Literature 2 and an annotation image are used, the annotation image being correctly color-coded with a color corresponding to each object in FIG. 10(c) of Patent Literature 2, as shown in FIG. 10(d) of Patent Literature 2. The artificial image capturing the interior of the virtual space as described in Patent Literature 2 is different in appearance from an actually captured photorealistic image due to differences in tone, shadow, reflection, light source and/or the like. Therefore, utilization of the non-photorealistic and artificial image for the learning data raises a problem of a possibility of a reduction in estimation accuracy in the learning based approach for the actually captured photorealistic image.

Furthermore, in Patent Literature 2, because a region of existence of an object as shown in FIG. 10(d) of Patent Literature 2 is projected to generate region information serving as teaching information, there is a problem of an inability to generate region information indicating a region of part of, rather than the whole of, an object of interest, for example, specific region information such as on a region used to tow the cart.

Also, NeRF is a technology with which, if the camera location is changed, a photorealistic image after the change in camera location is able to be generated. However, teaching information after the change in camera location is not able to be generated. Therefore, there is a problem of the need to generate teaching information manually.

Given these circumstances, a problem to be solved by the present invention is to provide a data generation device and a data generation method in which when a change in camera location and/or a change of camera bodies occurs, an image and teaching information which are learning data for the learning based approach are generated from the original learning data in order to achieve a reduction in person-hours to collect the learning data for the learning based approach.

### Solution to Problem

To solve the above-described problems, an aspect of the invention provides a data generation device including, for example: an image receiving portion that receives an image of an object of interest; a first parameter receiving portion that receives a first parameter which is a parameter of a real camera when the image of the object of interest is captured; a second parameter receiving portion that receives a second parameter which is a parameter of a virtual camera; a three-dimensional information receiving portion that receives three-dimensional information on the object of interest; a teaching information storage portion that receives and stores teaching information corresponding to the first parameter; a pseudo image generation portion that inputs the second parameter to a space constructor learned using at least the image and the first parameter in order to generate a pseudo image of the object of interest corresponding to the second parameter; and a teaching information update portion that uses the first parameter, the second parameter and the three-dimensional information to update the teaching information corresponding to the first parameter in the teaching information storage portion to teaching information corresponding to the second parameter.

Another aspect of the present invention also provides a data generation method including, for example: an image receiving step of receiving an image of an object of interest; a first parameter receiving step of receiving a first parameter which is a parameter of a real camera when the image of the object of interest is captured; a second parameter receiving step of receiving a second parameter which is a parameter of a virtual camera; a three-dimensional information receiving step of receiving three-dimensional information on the object of interest; a teaching information storing step of receiving and storing teaching information corresponding to the first parameter; a pseudo image generating step of inputting the second parameter to a space constructor learned using at least the image and the first parameter in order to generate a pseudo image of the object of interest corresponding to the second parameter; and a teaching information update step of using the first parameter, the second parameter and the three-dimensional information to update the teaching information corresponding to the first parameter to teaching information corresponding to the second parameter.

### Advantageous Effects of Invention

According to the present invention, even if the camera location and/or the camera bodies are changed, an image and teaching information which are learning data after change related to a camera can be generated from original learning data as learning data for the learning based approach, thus enabling a reduction in person-hours to collect the learning data for the learning based approach.

Objects, configurations, and effects other than the above will be apparent from the description of the following embodiments.

### BRIEF DESCRIPTION OF DRAWINGS

FIG. 1 is a functional block diagram illustrating a schematic configuration of a data generation device according to a first embodiment.

FIG. 2 is a functional block diagram illustrating a schematic configuration of a data generation device according to a second embodiment.

FIG. 3 is a functional block diagram illustrating a schematic configuration of a data generation device according to a third embodiment.

FIG. 4 is a functional block diagram illustrating a schematic configuration of a data generation device according to a fourth embodiment.

FIG. 5 is a diagram illustrating an example system to execute work to which the data generation device and the data generation method according to the embodiments are to be applied.

FIG. 6 is a diagram illustrating an example image captured by a camera in the system in FIG. 5.

FIG. 7 is a diagram for describing an issue in the system in FIG. 5.

FIG. 8 is a diagram for describing an issue in the system in FIG. 5.

FIG. 9 is an example of an information processing device partially making up the data generation device according to the first embodiment to the fourth embodiment.

### DESCRIPTION OF EMBODIMENTS

Embodiments according to the present invention will now be described below with reference to the accompanying diagrams. In each diagram and in each embodiment, the same reference signs indicate identical or similar elements, and a redundant description is omitted.

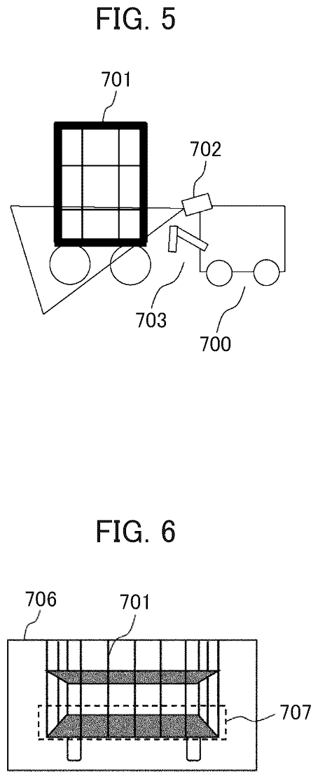

Initially, with reference to FIG. 5 to FIG. 8, a description is given of an example system and the issue to execute work to which a data generation device and a data generation method according to the embodiments are to be applied.

FIG. 5 is a diagram illustrating an example system to execute work to which the data generation device and the data generation method according to the embodiments are to be applied.

Work to tow a cart 701 in a warehouse or a factory by a guided vehicle 700 is described herein as an example, and is not intended to be limiting. The device and method may be applied to another work such as, for example, work to pick products in a warehouse by an automated robot which estimates a picking region and picks an object of interest, and the like.

As illustrated in FIG. 5, the guided vehicle 700 has a camera 702 for capturing the cart 701, and an end effector 703 for towing the cart 701.

FIG. 6 is a diagram illustrating an example image captured by a camera in the system in FIG. 5.

For determining a tow position on the cart 701, the guided vehicle 700 obtains an occupied region 707 which is a region used to tow the cart 701 in a captured camera image 706. As used herein, the occupied region 707 means an attended region of the cart 701 as an object of interest in the camera image 706, and the region may be the whole of the object of interest or may be a part of the object of interest. The case where the region is a part of the object of interest is herein described as an example.

Methods of determining a position for a tow include a method in which if, separately from the camera 702, for example, a sensor acquiring depth information is located, this enables acquisition of depth information corresponding to the occupied region 707, and a three-dimensional position (e.g., the underside of the cart) providing stable tow by the end effector 703 is defined as a position for tow. For estimation of a region used to tow the cart 701, for example, a machine learning based approach using DNN (Deep Neural Network) is used. A tow region which is teaching information and an image to be DNN learning data are manually labelled using, e.g., an annotation tool.

In such cart tow using the guided vehicle 700, as illustrated in FIG. 5, a region estimation DNN is created which learns in learning data having the camera image 706 and the teaching information with the occupied region 707 labelled, the camera image 706 capturing the cart 701 to be towed from a position/orientation of the camera 702 which is assumed by the guided vehicle 700. Then, the occupied region 707 can be estimated by using the learned region estimation DNN to input the camera image 706 of the cart 701 captured by the camera 702 in actual work.

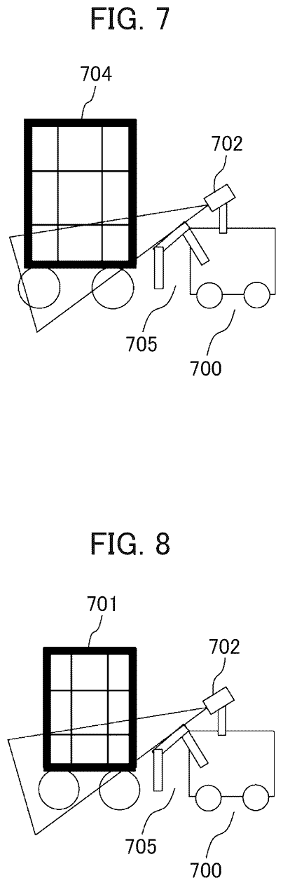

FIGS. 7 and 8 are diagrams for describing an issue in the system in FIG. 5.

As illustrated in FIG. 7, in association with a change in operational policy and/or expansion of handled items during development of or after introduction of the guided vehicle 700, a need may arise for a change to a new cart such as a heavy goods cart 704 which is not envisioned at the beginning of the development and/or the introduction, and/or the like. For merely illustrative purpose, the case is herein described where the heavy goods cart 704 has a similarity in shape to the cart 701 but is larger in size than the cart 701. Depending on an increase in weight of the heavy goods cart 704 which is a new cart or on a shape of the heavy goods cart 704, if towing is not achieved by the end effector 703, the end effector 703 is changed to a heavy goods end effector 704 for towing the heavy good cart 704, and due to the change, cases may be considered where the location of the camera 702 is changed and/or the camera 702 is replaced with another camera.

Further, as illustrated in FIG. 8, it can be considered that, using a heavy goods end effector 705 changed for the heavy goods cart 704 and the camera 702 after the change in location, the cart 701 before the change is designed to be also transported.

Also, even if a change to the heavy goods cart 704 and/or a change to the heavy goods end effector 705 are not made, cases may be considered where the location of the camera 702 is changed and/or the camera 702 is replaced with another camera during the development of or after the introduction of the guided vehicle 700.

In this manner, when at least one of the change related to the camera 702 (such as the change in location of the camera 702, the change from the camera 702 to another camera) and the change of objects of interest occurs, a photographed condition of the object of interest differs between the image used in the learning of the region estimation DNN and the image captured after the change related to the camera 702. If an image with a different photographed condition of the object of interest is input and the region estimation DNN which has learned in the learning data collected before the change is utilized, there is concern about a reduction in estimation accuracy for the occupied region.

In order to avoid such failure of estimation of the occupied region 707 after the change related to the camera 702 and/or change in the objects of interest, a method can be considered of re-performing and re-learning labeling of the occupied region 707 and the camera image 706 capturing the object of interest after the change related to the camera 702 and/or change in the objects of interest. However, in the above method, every time the change related to the camera 702 and/or the change in the objects of interest occurs, person-hours to re-collect the learning data are required.

To address this, regarding the change related to the camera 702, the data generation device and the data generation method according to a first embodiment to a fourth embodiment which will be described later may be applied in order to reduce the person-hours to collect the learning data. Further, regarding the change in the objects of interest, the data generation device and the data generation method according to the fourth embodiment which will be described later may be applied in order to reduce the person-hours to collect the learning data.

### First Embodiment

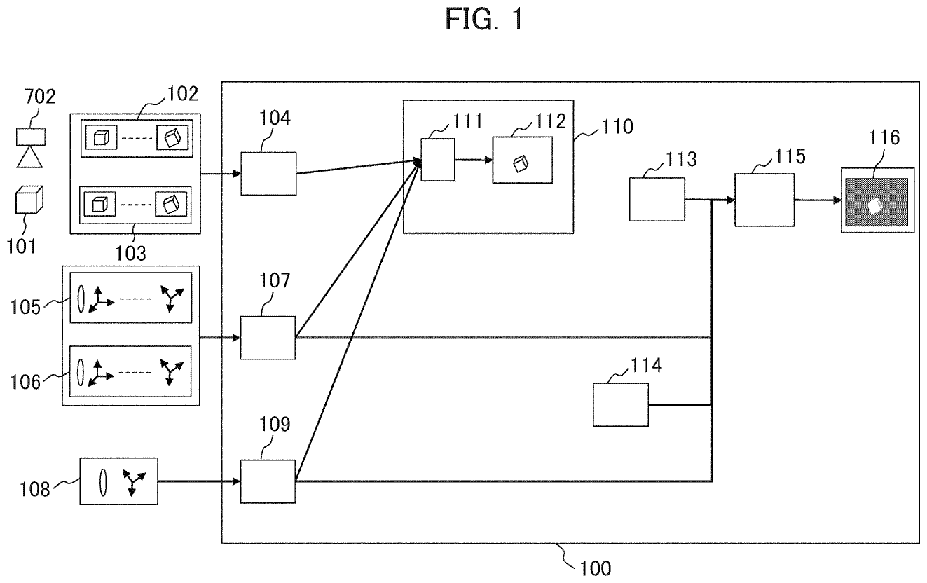

FIG. 1 is a functional block diagram illustrating a schematic configuration of a data generation device according to a first embodiment.

As illustrated in FIG. 1, a data generation device 100 in the present embodiment is configured to include, as major components, an image receiving portion 104, a first parameter receiving portion 107, a second parameter receiving portion 109, a pseudo image generation portion 110, a three-dimensional information receiving portion 113, a teaching information storage portion 114, and a teaching information update portion 115. In turn, the pseudo image generation portion 110 has a space constructor 111.

Next, the operation of the data generation device 100 and the data generation method will be described.

The image receiving portion 104 receives an image 102 of an object of interest 101 in an image receiving step. The image 102 is at least one image of the object of interest 101 captured by a camera 702. The image 102 may be newly captured. Alternatively, for the image 102, for example, data collected before the change related to the camera 702 in order to learn a region estimation DNN used in the system described in FIG. 5 may be used. Utilizing the collected data enables a reduction in person-hours. It is noted that, in addition to the image 102, an additional image 103 may be input to the image receiving portion 104. The image 102 and the additional image 103 are used to create the space constructor 111 which will be described later.

The additional image 103 may be, for example, an image captured by bringing about changes in position/orientation of the camera 702 relative to the positions/orientations of the camera 702 at which images included in the image 102 are captured respectively, and/or the additional image 103 may be, for example, an image captured by determining the position/orientation of the camera 702 without relation to the positions/orientations of the camera 702 at which images included in the image 102 are captured respectively. The additional image 103 does not need to have corresponding teaching information.

The image 102 and the additional image 103 are captured, for example, using the camera 702 of equipment to which one or more cameras 702 with known relative positions/orientations are fixed, and/or using a camera of a robot equipped with the camera 702. It is noted that, in the case of using the camera 702 of the robot, for example, what is needed is to know the installation orientation of the camera 702 when viewed from a reference coordinate system of the robot. Also, a person may take a photograph using the camera 702.

The first parameter receiving portion 107, in a first parameter receiving step, receives a first parameter 105 which is a parameter of a real camera when the image 102 of the object of interest 101 is captured. The first parameter receiving portion 107 may configured to receive additionally an additional first parameter 106 which is a parameter of the real camera when the additional image 103 is captured. The real camera as used herein means a camera in a real space.

The first parameter 105 and the additional first parameter 106 are parameters including, at least, information on a position, orientation and a focal length of the camera 702. The first parameter 105 and the additional first parameter 106 may be configured to include further parameters such as of an image center, a resolution and/or the like. For the position and orientation of the camera 702, for example, known values are used if a relative position/orientation is known when the image 102 and the additional image 103 are captured. Where photographing is performed using the robot, it is possible to calculate the amount of change in position and orientation of the camera between captured images from the movement information of the robot. Also, the position and orientation of the camera when capturing may be estimated from a plurality of images using a SfM (Structure from Motion) approach. Also, if the camera 702 is equipped with IMU (Internal Measurement Unit), a value obtained from IMU may be used for estimation. For an image center and/or a focal length of the camera, a design value of the camera 702 may be used or the SfM approach may be used for estimation.

The second parameter receiving portion 109, in a second parameter receiving step, receives a second parameter 108 which is a parameter of a virtual camera. The second parameter 108 of the virtual camera is composed of similar parameters to the first parameter 105 and the additional first parameter 106. For example, as a second parameter receiving portion 109, a parameter of the camera after the change related to the camera 702 as illustrated in FIG. 8 is input. The virtual camera as used herein means a camera in a virtual space handled by the data generation device 100.

First, the pseudo image generation portion 110, in a space constructor creation step, creates the space constructor 111 using the image 102, the additional image 103, the first parameter 105 and the additional first parameter 106. The space constructor 111 reconstructs a three-dimensional space of the captured environment, from images of the image 102 and the additional image 103, and parameters related to the camera of the first parameter 105 and the additional first parameter 106. The three-dimensional space is reconstructed, for example, using a three-dimensional reconstruction approach and/or the NeRF approach, in which the three-dimensional reconstruction approach uses the SfM approach of estimating a position and orientation of the camera when capturing from a plurality of images, and an MVS (Multi View Stereo) approach of using a plurality of images to reproduce a three-dimensional point cloud of a scene, and the NeRF approach uses the image capturing the object of interest and the parameter of the camera when capturing to learn a neural network representing the captured three-dimensional space in order to generate a photorealistic image of the object of interest captured by a camera virtually located. In the present embodiment, the case of using the NeRF approach is described, but another approach regarding the three-dimensional reconstruction may be used. It is noted that using the additional image 103 and the additional first parameter 106 is optional and the image 102 and the first parameter 105 may be used to create the space constructor 111.

Then, the pseudo image generation portion 110, in a pseudo image generating step, inputs the second parameter 108 to the space constructor 111 learned using at least the image 102 and the first parameter 105 in order to generate a pseudo image 112 of the object of interest 101 corresponding to the second parameter 108.

The pseudo image 112 is an image outputted at a virtual resolution by locating the camera having a virtual focal length and image center at the camera position/orientation of the second parameter 108 of the virtual camera. The pseudo image 112 is a virtual image captured by the camera 702 with the position/orientation after the change related to the camera 702 as illustrated in FIG. 8, for example. Because of this, using as the learning data is enabled, and thus the person-hours to collect the learning data may be reduced. Also, the space constructor 111 is able to generate the photorealistic pseudo image 112. Because of this, as compared with the case of using, as learning data, a non-photorealistic and artificial image in which a scene is reproduced by three-dimensional computer graphics, the possibility of a reduction in estimation accuracy may be minimized.

The three-dimensional information receiving portion 113 receives three-dimensional information on the object of interest 101 in a three-dimensional information receiving step. As three-dimensional information, for example, a three-dimensional model, a pseudo depth image, a depth image and/or the like may be used, and are not intended to be limiting.

The teaching information storage portion 114 receives and stores teaching information corresponding to the first parameter 105 in a teaching information storing step. As teaching information, for example, orientation information and/or region information related to the object of interest 101, and/or the like may be used, and are not intended to be limiting. The teaching information corresponding to the first parameter 105 is associated with the image 102 received at the image receiving portion 104. The teaching information corresponding to the first parameter 105 may be newly created, but, for example, teaching information created before the change related to the camera 702 in order to learn the region estimation DNN used in the system described in FIG. 5 may also be used. Utilization of the created data enables a reduction in person-hours. Also, where the region information is used as teaching information, the region information indicating a part of the object of interest 101 may be used.

The teaching information update portion 115, in a teaching information update step, uses the first parameter 105, the second parameter 108 of the virtual camera and the three-dimensional information on the object of interest 101, to update the teaching information corresponding to the first parameter 105 in the teaching information storage portion 114 to teaching information 116 corresponding to the second parameter 108. The teaching information 116 is teaching information corresponding to the pseudo image 112 captured by the camera 702 with the position/orientation after the change related to the camera 702 as illustrated in FIG. 8, for example. Because of this, using as the learning data is enabled, and thus the person-hours to collect the learning data may be reduced. The teaching information 116 is, for example, region information on the object of interest 101 corresponding to the pseudo image 112, and is not intended to be limiting.

As described above, with the data generation device 100 and the data generation method according to the present embodiment, even if a camera location is changed and/or camera bodies are changed, as learning data for the learning based approach, an image and teaching information which are leaning data after the change related to the camera are able to be generated from the original learning data, and thus a reduction in person-hours to collect the learning data for the learning based approach is achieved.

In the following embodiments, a specific example configuration and functionality of the data generation device 100 will be described.

### Second Embodiment

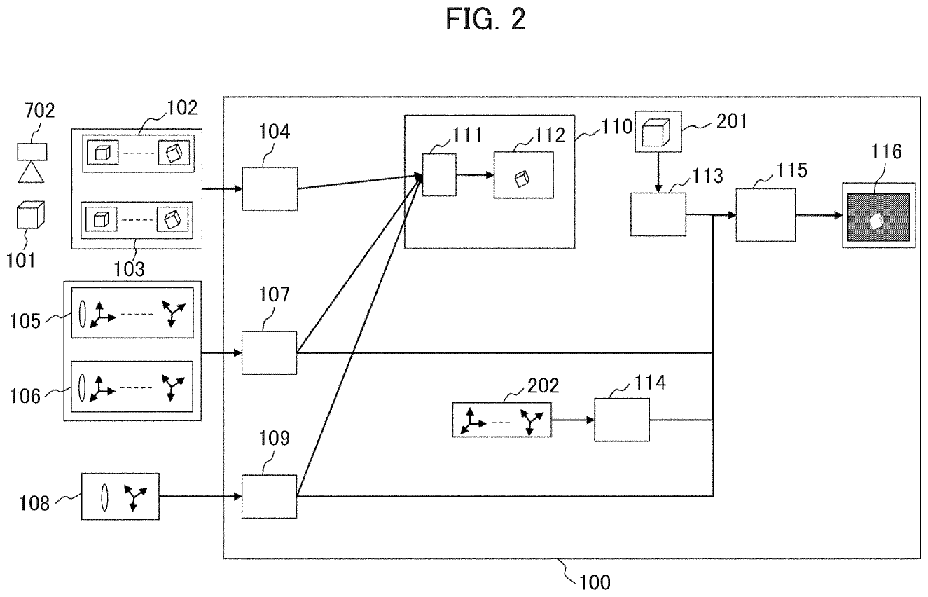

FIG. 2 is a functional block diagram illustrating a schematic configuration of a data generation device according to a second embodiment.

The second embodiment is an embodiment provided in a more specific manner than the first embodiment. In the second embodiment and subsequent embodiments, a description overlapping with the first embodiment is omitted.

As illustrated in FIG. 2, the data generation device 100 according to the present embodiment is a specific example in the case where the three-dimensional information on the object of interest 101 received at the three-dimensional information receiving portion 113 is a three-dimensional model 201 of the object of interest 101, the teaching information corresponding to the first parameter 105 received at the teaching information storage portion 114 is orientation information 202 on the object of interest 101, and the teaching information 116 corresponding to the second parameter 108 is region information on a pseudo image 112.

The three-dimensional model 201 of the object of interest 101 is obtained, for example, by using a three-dimensional scanner to capture the object of interest 101. The three-dimensional model 201 of the object of interest 101 is, for example, crated by scanning a certain part of the object of interest 101 which is intended to become an occupied region in the image 102, or alternatively, created by scanning the whole of the object of interest 101. If the three-dimensional model 201 of the object of interest 101 is created by scanning the whole of the object of interest 101, the region information on the object of interest 101 which is intended to be the occupied region in the image 102 may be included.

For obtaining the orientation information 202, for example, a person uses an annotation tool to select a two-dimensional point on the image 102 corresponding to a characteristic three-dimensional point of the three-dimensional model 201 of the object of interest 101 so that PnP (Perspective-n-Point) problem is solved.

Then, a description is given of the processing of the teaching information update portion 115 in which the orientation information 202 as the teaching information corresponding to the first parameter 105 is updated to the teaching information 116 corresponding to the second parameter 108.

Assume that M is a coordinate system of the three-dimensional model 201 of the object of interest 101, Cam_i (i is an index corresponding to an image belonging to the image 102) is a coordinate system of the camera 702, VCam is a coordinate system of the virtual camera, and Base is a reference coordinate system. Base is a coordinate system set in a characteristic place in a space in which photographing is performed, which is set, for example, on a floor or a desk on which the object of interest 101 is placed.

Assume that T is information indicating position and orientation, one before symbol \hat{ } signifies a superscript, and one after symbol _ signifies a subscript. The orientation information 202 corresponding to the first parameter 105 is represented as Cam_i\hat{ }T_M. The information indicating position and orientation of the first parameter 105 is represented as Cam_i\hat{ }T_Base. The information indicating position and orientation of the second parameter of the virtual camera is represented as VCam\hat{ }T_Base. The representation of Cam_i\hat{ }T_M, Cam_i\hat{ }T_Base and VCam\hat{ }T_Base is assumed, for example, as a homogeneous 4-by-4 transformation matrix.

Initially, at the teaching information update portion 115, by using Equation (1), Cam_i\hat{ }T_M which is the orientation information 202 corresponding to the first parameter 105 input to the teaching information update portion 115 is transformed to VCam\hat{ }T_M which is orientation information represented in a coordinate system (VCam) of the virtual camera.

$$\begin{matrix}[ Equation 1 ] & \\ {T}_{M}^{VCam} = {T}_{Base}^{VCam} \cdot {( {T}_{Base}^{{Cam}_{i}} )}^{- 1} \cdot {T}_{M}^{{Cam}_{i}} & ( 1 )\end{matrix}$$

Then, assume that L is a region. Equation (2) is used to obtain VCam\hat{ }L_M which is a region occupied on an image plane by the three-dimensional model 201 of the object of interest 101 as viewed from the virtual camera. The VCam\hat{ }L_M is output as the teaching information 116 corresponding to the second parameter 108.

$$\begin{matrix}[ Equation 2 ] & \\ {L}_{M}^{VCam} = projecion ( {A}_{VCam} , {T}_{M}^{VCam} , {Model}_{201} ) & ( 2 )\end{matrix}$$

In Equation (2), A indicates parameter information, and A_VCam represents the information indicating a focal length, an image center, a resolution of the second parameter 108 of the virtual camera. The three-dimensional model 201 of the object of interest 101 is stated as Model_201. Projection is a function that projects the three-dimensional model 201 of the object of interest 101 onto an image plane of the virtual camera using A_VCam of the parameter information on the virtual camera and VCam\hat{ }T_M of the orientation information in the coordinate system of the virtual camera obtained from Equation (1), and generates VCam\hat{ }L_M which is a region occupied on the image plane by the three-dimensional model 201 of the object of interest 101 as viewed from the virtual camera, where the three-dimensional model 201 of the object of interest 101 is represented in the coordinate system (VCam) of the virtual camera.

The region VCam\hat{ }L_M is, for example, the region information on the pseudo image 112, which is presented in image format and is a binary image such that a pixel value for a region information part related to the object of interest 101 is assigned zero and other regions are assigned 1.

It is noted that the three-dimensional model 201 of the object of interest 101 is generated by scanning the whole of the object of interest 101. If the region information on the object of interest 101 which is intended to become an occupied region in the image 102 is included, when the three-dimensional model 201 of the object of interest 101 is projected on the image plane of the virtual camera in terms of projection, only the appropriate region information may be projected to be generated as the region VCam\hat{ }L_M.

The processing as described above makes it possible to update the orientation information 202 which is the teaching information corresponding to the first parameter 105 to the teaching information 116 corresponding to the second parameter 108, thus enabling a reduction in person-hours to collect the learning data.

### Third Embodiment

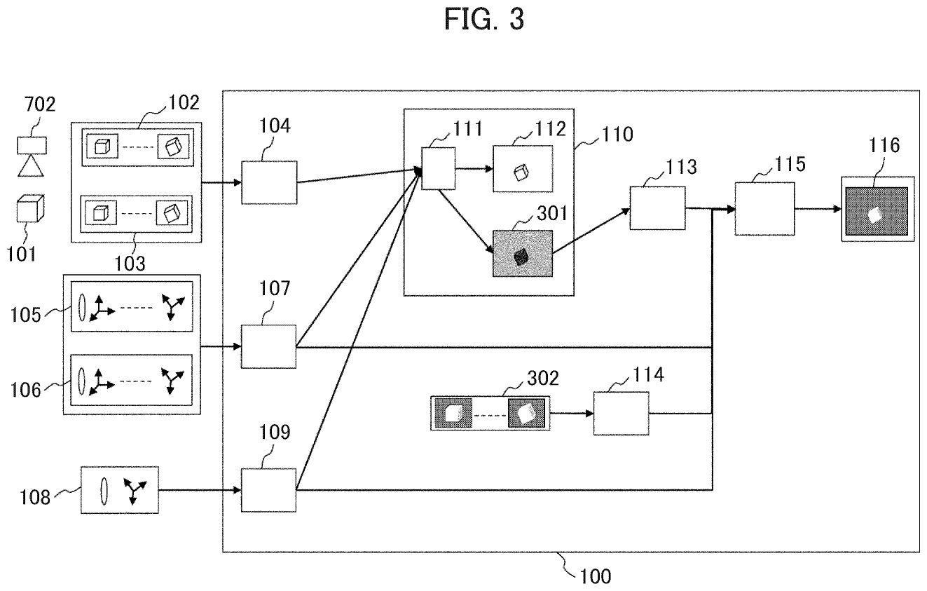

FIG. 3 is a functional block diagram illustrating a schematic configuration of a data generation device according to a third embodiment.

The third embodiment is another embodiment provided in a more specific manner than the first embodiment.

As illustrated in FIG. 3, the data generation device 100 according to the present embodiment is a specific example in the case where: the pseudo image generation portion 110 inputs the first parameter 105 to the space constructor 111 in order to generate a pseudo depth image 301 of the object of interest 101 corresponding to the first parameter 105; the three-dimensional information on the object of interest 101 received at the three-dimensional information receiving portion 113 is the pseudo depth image 301 of the object of interest 101 generated at the space constructor 111; the teaching information corresponding to the first parameter 105 received at the teaching information storage portion 114 is region information 302; and the teaching information corresponding to the second parameter 108 is region information on the pseudo image 112.

Initially, the processing in the pseudo image generation portion 110 is described.

Similarly to the first embodiment, the pseudo image generation portion 110 inputs the second parameter 108 to the space constructor 111 in order to generate the pseudo image 112 of the object of interest 101 corresponding to the second parameter 108. Similarly to the first embodiment, the pseudo image 112 may be utilized as the learning data.

In addition to the above-described processing, the pseudo image generation portion 110 according to the present embodiment inputs the first parameter 105 to the space constructor 111 in order to generate the pseudo depth image 301 of the object of interest 101 corresponding to the first parameter 105. The pseudo depth image 301 may be utilized as the three-dimensional information on the object of interest 101 received at the three-dimensional information receiving portion 113. At this time, the pseudo image 112 of the object of interest 101 corresponding to the first parameter 105 may also be generated, but which is not utilized in the present embodiment.

If, for example, the NeRF approach is used for the space constructor 111, the space constructor 111 is able to generate the pseudo depth image 301 corresponding to the pseudo image 112, in addition to the pseudo image 112. Because of this, use as the space constructor 111 according to the present embodiment is possible.

The region information 302 which is the teaching information corresponding to the first parameter 105 is obtained by, for example, a person using an annotation tool to create a mask image for a specific region of the object of interest 101 on the image 102.

Then, a description is given of the processing of the teaching information update portion 115 in which the region information 302 as the teaching information corresponding to the first parameter 105 is updated to the teaching information 116 corresponding to the second parameter 108.

In addition to the variable representation described in the second embodiment, the information indicating a focal length, an image center, a resolution of the first parameter 105 is represented as A_Cam_i. Also, the region information 302 corresponding to the first parameter 105 is represented as L_Cam_i. L_Cam_i is presented, for example, in image format and is a binary image such that a pixel value for a region information part related to the object of interest 101 is assigned zero and other regions are assigned 1. Also, assume that D is a pseudo depth image. The pseudo depth image 301 corresponding to the first parameter 105 utilized as the three-dimensional information on the object of interest 101 is represented as D_Cam_i. It is noted that the pseudo depth image 301 corresponding to the image 102 may be generated by inputting the first parameter 105 (A_Cam_i and Cam_i\hat{ }T_Base) to the space constructor 111.

Initially, the teaching information update portion 115 uses Equation (3) to acquire a three-dimensional point cloud (PC_Cam_i) corresponding to the region information 302 related to the object of interest 101 corresponding to the first parameter 105. PC is the three-dimensional point cloud. Deprojection is a function that acquires a pixel value of the pseudo depth image 301 (D_Cam_i) corresponding to the region information 302 (L_Cam_i) and uses the parameter information (A_Cam_i) on the first parameter 105 to calculate a three-dimensional point.

[Equation 3]

PC_{Cam}_{ᵢ}=deprojection(A_{Cam}_{ᵢ},D_{Cam}_{ᵢ},L_{Cam}_{ᵢ}) (3)

Then, Equation (4) is used to obtain a region VCam\hat{ }L_PC occupied on an image plane as the three-dimensional point cloud PC_Cam_i obtained from Equation (3) is viewed from the virtual camera. Projection_PC is a function that transforms the three-dimensional point could PC_Cam_i to a point cloud as viewed from above virtual camera coordinates VCam using (VCam\hat{ }T_Base)·(Cam_i\hat{ }T_Base)\hat{ }(−1), and projects the transformed point cloud on an image plane of the virtual camera in order for the point cloud to create a region occupied on the image plane using the parameter information A_VCam on the virtual camera. Because the region VCam\hat{ }L_PC obtained from Equation (4) can be utilized as the teaching information 116 corresponding to the second parameter 108, this may be output as the teaching information 116 corresponding to the pseudo image 112.

$$\begin{matrix}[ Equation 4 ] & \\ {L}_{PC}^{VCam} = projection\_PC ( {A}_{VCam} , {T}_{Base}^{VCam} . ( {T}_{Base}^{{Cam}_{i}} ) , {PC}_{{Cam}_{i}} ) & ( 4 )\end{matrix}$$

On the other hand, depending on the combination of the object of interest 101, the first parameter 105 and the second parameter 108 of the virtual camera, a case can be considered where the region VCam\hat{ }L_PC obtained from Equation (4) is actually equivalent to a shadowed part of the object of interest 101 (the other side of the object of interest 101 as viewed from the virtual camera), which is a region invisible on the image in actuality. Therefore, a method for additionally performing the following processing can be considered.

Initially, the teaching information update portion 115 uses Equation (5) to transform the three-dimensional point cloud PC_Cam_i corresponding to the region information 302 on the object of interest 101 to the point cloud PC_VCam in the virtual camera coordinate representation.

$$\begin{matrix}[ Equation 5 ] & \\ {PC}_{VCam} = {T}_{Base}^{VCam} \cdot {( {T}_{Base}^{{Cam}_{i}} )}^{- 1} \cdot {PC}_{{Cam}_{i}} & ( 5 )\end{matrix}$$

Also, the pseudo image generation portion 110 uses the space constructor 111 to obtain a pseudo depth image corresponding to the second parameter 108 of the object of interest 101 (the pseudo depth image corresponding to the pseudo image 112), and inputs the pseudo depth image to the teaching information update portion 115. Specifically, the second parameter 108 (A_VCam and VCam\hat{ }T_Base) is input to the space constructor 111 to generate a pseudo depth image (D_VCam) corresponding to the pseudo image 112.

Then, for each pixel indicating the region information on the region VCam\hat{ }L_PC, a pixel value of the corresponding pseudo depth image D_VCam and a z coordinate value of a three-dimensional point of the point cloud PC_VCam in the virtual camera coordinate representation are acquired. Then, when the acquired pixel value of the pseudo depth image D_VCam is smaller than the z coordinate value of the three-dimensional point of the point cloud PC_VCam, the three-dimensional point of the point cloud PC_VCam is assumed to be present in the shadowed part of the object of interest 101, so that the pertinent region information is removed from the region VCam\hat{ }L_PC.

Finally, verification is performed, using GUI and/or the like, to check that the created pseudo image 112 and the teaching information 116 corresponding to the pseudo image 112 are correctly generated. Because of the verification using GUI and/or the like, an incorrect pseudo image 112 and the teaching information 116 corresponding to the pseudo image 112 are removed from the learning data. Thus, the incorrect learning about the relationship between the cart 701 as an existing object of interest to be towed and the teaching information is prevented, which in turn make it possible to prevent a reduction in estimation accuracy related to the cart 701.

The present embodiment uses the pseudo depth image 301 generated in the space constructor 111 as three-dimensional information on the object of interest 101 received at the three-dimensional receiving portion 113, but the depth information acquired through another method can be used. For example, if the camera 702 is a camera capable of acquiring a depth image, the depth image acquired by the camera 702 may be used.

The processing as described above makes it possible to update the region information 302 which is the teaching information corresponding to the first parameter 105 to the teaching information 116 corresponding to the second parameter 108, thus enabling a reduction in person-hours to collect the learning data.

### Fourth Embodiment

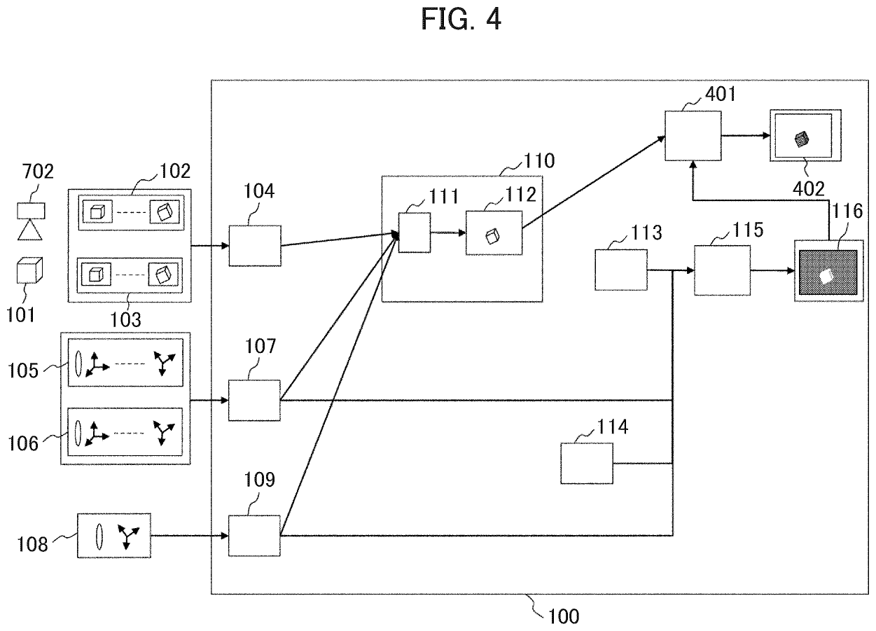

FIG. 4 is a functional block diagram illustrating a schematic configuration of a data generation device according to a fourth embodiment.

The fourth embodiment is an embodiment when an image augmentation function is added to the first embodiment. It is noted that a case of being applied to the first embodiment is described here by way of example, but application to the second embodiment or the third embodiment is possible.

As illustrated in FIG. 4, the data generation device 100 according to the present embodiment has an image augmentation portion 401.

In an image augmentation step, the image augmentation portion 401 uses the pseudo image 112 of the object of interest 101 corresponding to the second parameter 108 and the teaching information 116 corresponding to the second parameter 108 (the teaching information 116 corresponding to the pseudo image 112) to perform image processing on the pseudo image 112 in order to generate an augmented pseudo image 402 differing from the pseudo image 112.

Examples of the image processing include an example of processing to change uniformly the pixel values in the region of the pseudo image 112 corresponding to the region information indicated by the teaching information 116 corresponding to the second parameter 108, for example, the processing to change the hue, chroma and/or brightness of the pixel values by a certain value. Also, as another example of the image processing, processing is included to zoom in and/or out of the inside of the region of the pseudo image 112 corresponding to the region information indicated by the teaching information 116 corresponding to the second parameter 108.

By use of the present embodiment, where, for example, the heavy goods cart 704 as illustrated in FIG. 7 is similar in appearance to the cart 701 as an existing object of interest to be towed, the augmented pseudo image 402 is generated as the learning data for the heavy goods cart 704, thereby enabling a reduction in the person-hours to collect the learning data for the heavy goods cart 704. It is noted that application to the cart 701 which is an existing object of interest to be towed enables a reduction in person-hours to collect the learning data for the cart 701 which is an existing object of interest to be towed.

### Fifth Embodiment

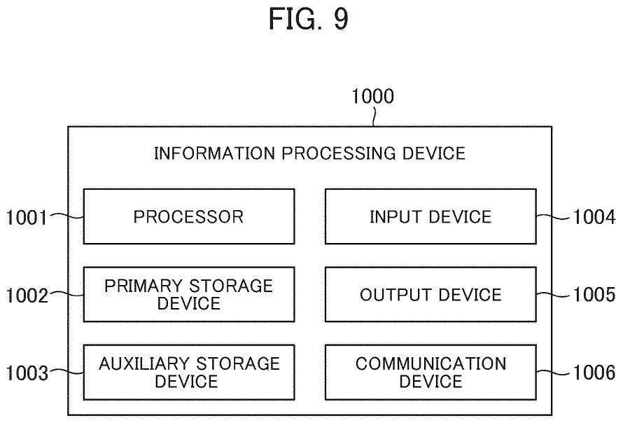

FIG. 9 is an example of an information processing device partially making up the data generation device according to the first embodiment to the fourth embodiment.

A fifth embodiment is an embodiment describing an example hardware configuration of an information processing device (computer) used to implement the data generation device 100 according to the first to fourth embodiments.

As illustrated in FIG. 9, an information processing device 1000 according to the present embodiment includes a processor 1001, a primary storage device 1002, an auxiliary storage device 1003, an input device 1004, an output device 1005 and a communication device 1006. The above devices are communicatively connected to each other via communication means such as a bus which is not shown, and/or the like.

It is noted that the information processing device 1000 may make up, for example, part of another system to which the machine learning system in question is applied such as a microcomputer installed in a robot arm (manipulator). Also, the information processing device 1000 may be implemented by use of, for example, virtual information processing resources such as a cloud server provided by a cloud system.

The processor 1001 is configured using, for example, CPU (Central Processing Unit), MPU (Micro-Processing Unit), FPGA (Field-Programmable Gate Array), GPU (Graphics Processing Unit), AI chip and/or the like.

The primary storage device 1002 is a device to store programs and/or data, which is, for example, ROM (Read Only Memory), RAM (Random Access Memory), non-volatile memory (NVRAM (Non-Volatile RAM)) and/or the like.

The auxiliary storage device 1003 is, for example, a hard disk drive, SSD (Solid State Drive), an optical storage device (CD (Compact Disc), DVD (Digital Versatile Disc) and/or the like), a storage system, an IC (Integrated Circuit) card, an SD card, a read/write device of a recording medium such as an optical recording medium and/or the like, a storage area of a cloud server, and/or the like. A program and/or data is able to be read into the auxiliary storage device 1003 via a read device of a recording medium and/or the communication device 1006. The program and/or data stored in the auxiliary storage device 1003 is read into the primary storage device 1002 on an as needed basis.

The input device 1004 is an interface through which to receive input from the outside, which is, for example, a keyboard, a mouse, a touch panel, a card reader, a voice input device and/or the like.

The output device 1005 is an interface through which to output various pieces of information on processing progress, processing results and/or the like. The output device 1005 is, for example, a display device to visualize the above-described various pieces of information (a liquid crystal monitor, LCD (Liquid Crystal Display), a graphic card and/or the like), a device to vocalize the above-described various pieces of information (a voice output device (speaker and/or the like)), a device to transform the above-described various pieces of information into text (print device and/or the like). It is noted that, for example, the information processing device 1000 may be configured to input and/or output information to and/or from another device via the communication device 1006.

The communication device 1006 is a device to implement communications with another device, The communication device 1006 is a wired or wireless communication interface to implement communication with another device via communication means such as LAN (Local Area Network), WAN (Wide Area Network), the internet and/or the like. The communication device 1006 is, for example, NIC (Network Interface Card), a wireless communication module, a USB (Universal Serial Bus) module, a serial communication module and/or the like.

The image receiving portion 104, the first parameter receiving portion 107, the second parameter receiving portion 109, the pseudo image generation portion 110, the three-dimensional information receiving portion 113, the teaching information storage portion 114, the teaching information update portion 115 and the image augmentation portion 401, which have been described above, are implemented by, for example, the processor 1001 of the information processing device 1000 reading and executing a program stored in the primary storage device 1002.

Also, the primary storage device 1002 and the auxiliary storage device 1003 store: the image and the additional image 103; the first parameter 105 and the additional first parameter 106; the second parameter 108; various parameters defining the space constructor 111 of the pseudo image generation portion 110; the pseudo image 112 and the pseudo depth image 301; the three-dimensional model 201 of the object of interest 101; the orientation information 202 and the region information 302; the augmented pseudo image 402; and the teaching information 116 corresponding to the second parameter 108.

Some or all of each of the configurations, functionality, processing portions, processing means and the like which have been described above may be implemented by hardware by, for example, designing an integrated circuit and/or the like, or alternatively may be implemented by software by the processor interpreting and executing a program for implementing each function.

Information in the program, table, file and/or the like for implementing each function can be stored in a storage device such as memory, a hard disk, SSD and/or the like or alternatively on a recoding medium such as an IC card, an SD card, DVD and/or the like.

It should be noted that the present invention is not limited to the embodiments described above, and includes various modifications. For example, the above-described embodiments have been described using a cart, but instead another object of interest may be used. Further, the above-described embodiments have been described in detail for clarity of the present invention, and the present invention is not necessarily limited to including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

100: data generation device, 101: object of interest, 102: image, 103: additional image, 104: image receiving portion, 105: first parameter, 106: additional first parameter, 107: first parameter receiving portion, 108: second parameter, 109: second parameter receiving portion, 110: pseudo image generation portion, 111: space constructor, 112: pseudo image, 113: three-dimensional information receiving portion, 114: teaching information storage portion, 115: teaching information update portion, 116: teaching information corresponding to second parameter, 201: three-dimensional model of object of interest, 202: orientation information, 301: pseudo depth image, 302: region information, 401: image augmentation portion, 402: augmented pseudo image, 700: guided vehicle, 701: cart, 702: camera, 703: end effector, 704: heavy goods cart, 705: heavy goods end effector, 706: camera image, 707: occupied region, 1000: information processing device, 1001: processor, 1002: primary storage device, 1003: auxiliary storage device, 1004: input device, 1005: output device, 1006: communication device

1. A data generation device, comprising:
an image receiving portion that receives an image of an object of interest;
a first parameter receiving portion that receives a first parameter which is a parameter of a real camera when the image of the object of interest is captured;
a second parameter receiving portion that receives a second parameter which is a parameter of a virtual camera;
a three-dimensional information receiving portion that receives three-dimensional information on the object of interest;
a teaching information storage portion that receives and stores teaching information corresponding to the first parameter;
a pseudo image generation portion that inputs the second parameter to a space constructor learned using at least the image and the first parameter in order to generate a pseudo image of the object of interest corresponding to the second parameter; and
a teaching information update portion that uses the first parameter, the second parameter and the three-dimensional information to update the teaching information corresponding to the first parameter in the teaching information storage portion to teaching information corresponding to the second parameter.

2. The data generation device according to claim 1, wherein
the three-dimensional information on the object of interest is a three-dimensional model of the object of interest,
the teaching information corresponding to the first parameter is orientation information on the object of interest, and
the teaching information corresponding to the second parameter is region information on the pseudo image.

3. The data generation device according to claim 1, wherein
the pseudo image generation portion inputs the first parameter to the space constructor in order to generate a pseudo depth image of the object of interest corresponding to the first parameter,
the three-dimensional information on the object of interest is the pseudo depth image of the object of interest,
the teaching information corresponding to the first parameter is region information on the object of interest, and
the teaching information corresponding to the second parameter is region information on the pseudo image.

4. The data generation device according to claim 1, further comprising
an image augmentation portion that uses the pseudo image of the object of interest corresponding to the second parameter and the teaching information corresponding to the second parameter to perform image processing on the pseudo image in order to generate an augmented pseudo image.

5. The data generation device according to claim 1, wherein
the first parameter and the second parameter are parameters including, at least, information on a position, orientation and a focal length of either the real camera or the virtual camera.

6. The data generation device according to claim 1, wherein
the space constructor generates the pseudo image in a photorealistic manner.

7. The data generation device according to claim 1, wherein
the teaching information corresponding to the second parameter is region information indicating a part of the object of interest in the pseudo image.

8. The data generation device according to claim 1, wherein
the image is an image captured using either equipment to which one or more cameras with known relative positions/orientations are fixed, or a robot having a camera, the robot with known installation orientation of the camera when viewed from a reference coordinate system of the robot.

9. A data generation method, comprising:
an image receiving step of receiving an image of an object of interest;
a first parameter receiving step of receiving a first parameter which is a parameter of a real camera when the image of the object of interest is captured;
a second parameter receiving step of receiving a second parameter which is a parameter of a virtual camera;
a three-dimensional information receiving step of receiving three-dimensional information on the object of interest;
a teaching information storing step of receiving and storing teaching information corresponding to the first parameter;
a pseudo image generating step of inputting the second parameter to a space constructor learned using at least the image and the first parameter in order to generate a pseudo image of the object of interest corresponding to the second parameter; and
a teaching information update step of using the first parameter, the second parameter and the three-dimensional information to update the teaching information corresponding to the first parameter to teaching information corresponding to the second parameter.
